(19) United States
(12) Patent Application Publication
(10) Pub. No.: US 2022/0290703 A1
(43) Pub. Date: Sep. 15, 2022

(54) APPARATUSES FOR SECURING A MOUNT TO A SUBSTRATE

(71) Applicant: Hewlett-Packard Development Company, L.P., Spring, TX (US)

(72) Inventors: Hai-Lung Hung, Taipei City (TW); Cheng-Yi Yang, Taipei City (TW); Szu Tao Tong, Taipei City (TW)

(73) Assignee: Hewlett-Packard Development Company, L.P., Spring, TX (US)

(21) Appl. No.: 17/606,549

(22) PCT Filed: Jul. 31, 2019
(86) PCT No.: PCT/US2019/044479

§ 371 Date: Oct. 26, 2021

(51) Int. Cl. F16B 2/06; F16M 13/02

(52) U.S. Cl. CPC F16B 2/065; F16M 13/02

(57) ABSTRACT

An apparatus may include a collar, a first bracket and a second bracket. The collar may be retained in a substrate through hole of a substrate. For example, a portion of the collar may be inserted into the substrate through hole. The first bracket may include a first bracket screw hole and the second bracket may include a second bracket screw hole. The second bracket may be adjustable from a first (down) position to a second (upright) position. When the second bracket is in the first position, a mount retaining screw may be received through the first bracket screw hole to retain a mount to the substrate for a first thickness of the substrate. When the second bracket is in the second position, the mount retaining screw may be received through the second bracket screw hole to retain the mount to adjust to a second thickness of the substrate.

### BACKGROUND

Devices such as an all-in-one (AIO) computer may be mounted on a substrate such as tabletop or desktop via a mount. The mount may include a base for stability. Some mounts may be secured to the substrate through screws or other fasteners to increase stability.

### BRIEF DESCRIPTION OF THE DRAWINGS

Features of the present disclosure may be illustrated by way of example and not limited in the following figure(s), in which like numerals indicate like elements, in which:

FIG. 1A shows an exploded, perspective view of an example apparatus for securing a mount to a substrate;

FIG. 1B shows a perspective view of an assembled example of the apparatus illustrated in FIG. 1A;

FIG. 2 shows an unassembled perspective view of an example device mounting system that includes the apparatus depicted in FIGS. 1A and 1B;

FIG. 3 shows examples of mounts, in partial cross-section, that are secured to a substrate by the apparatus depicted in FIGS. 1A and 1B;

FIG. 4 shows an assembled view, in partial cross section, of an example system depicted in FIGS. 2 and 3;

FIG. 5A shows a side view in partial cross-section of an example assembly of an apparatus securing a mount to a surface of a substrate in a configuration in which a first bracket is in an upright position and a second bracket (shown by its arms) is in a down position to accommodate a first thickness of the substrate;

FIG. 5B shows a side view in partial cross-section of an example assembly of an apparatus securing a mount to a surface of a substrate in a configuration in which the first and second brackets are in an upright position to accommodate a second thickness of the substrate;

FIG. 5C shows a side view in partial cross-section of an example assembly of an apparatus securing a mount to a surface of a substrate in a configuration in which the first bracket is in a down position and the second bracket is in an upright position to accommodate the second thickness of the substrate; and

FIG. 5D shows a side view in partial cross-section of an example assembly of an apparatus securing a mount to a surface of a substrate in a configuration in which the first bracket is in a down position and the second bracket is in an upright position to accommodate the second thickness of the substrate and the second bracket is in an inside configuration relative to the first bracket.

### DETAILED DESCRIPTION

For simplicity and illustrative purposes, the present disclosure may be described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. Throughout the present disclosure, the terms “a” and “an” may be intended to denote at least one of a particular element. As used herein, the term “includes” means includes but not limited to, the term “including” means including but not limited to. The term “based on” means based at least in part on.

Devices, such as AIO computes or display devices, may be supported by a mount on a surface of a substrate such as a tabletop or desktop. Some mounts may include a large base that occupies a large portion of the surface. Furthermore, some mounts may be unstable and present a tipping risk for the device that the mount supports. As a result, these mounts may occupy valuable space, and may be unstable and aesthetically unpleasing. Other mounts may be directly screwed into the substrate. While stability may be improved with these mounts, there is still the possibility that inappropriate screw lengths may be used for different types and thicknesses of different substrates. As such, these mounts may not provide high stability, ease of use, and aesthetically pleasing appearance.

Disclosed herein are examples of an apparatus such as an adjustable counter-mount apparatus that secures a mount to a substrate. The apparatus may be adjusted to accommodate various substrate thicknesses while reducing the amount of space the mount occupies and improving stability. For example, the apparatus may include a collar and two brackets (which may include a pair of arms and a body in a U-shaped configuration) connected to the collar. Other numbers of brackets may be used as well. The collar may be inserted into a hole drilled through the substrate. The collar may include a flange that prevents the collar from being completely inserted into the hole. The collar may be generally flush against the bottom-side of the substrate (except for the thickness of the flange). The brackets may include a first bracket that may be sized for use with a roughly 10 mm thick substrate and a second bracket that may be sized to adjust the apparatus for use with a roughly 50 mm thick substrate. Other size brackets may be used as well. Furthermore, in some examples, the second bracket may include slots for adjustable configurations, although these examples may weaken the apparatus.

In some examples, the second bracket may be adjustable between a first (down) position and a second (upright) position. When the second bracket is in the first (down) position, the first bracket may be used to connect the apparatus to the mount via a mount retaining screw (which may be a thumb screw that can be hand-tightened) that is screwed through the first bracket to the mount. When the second bracket is in the second (upright) position, the second bracket may be used to connect the apparatus to the mount via the mount retaining screw that is screwed through the first bracket and the second bracket to the mount. In some examples, a single mount retaining screw may be used for simplicity and ease of use. In these examples, the mount retaining screw may be substantially centered in the collar for stability of the mount retaining screw. In some examples, the collar and the brackets may define a through-space where wires from the mount may be passed to the bottom-side of the substrate.

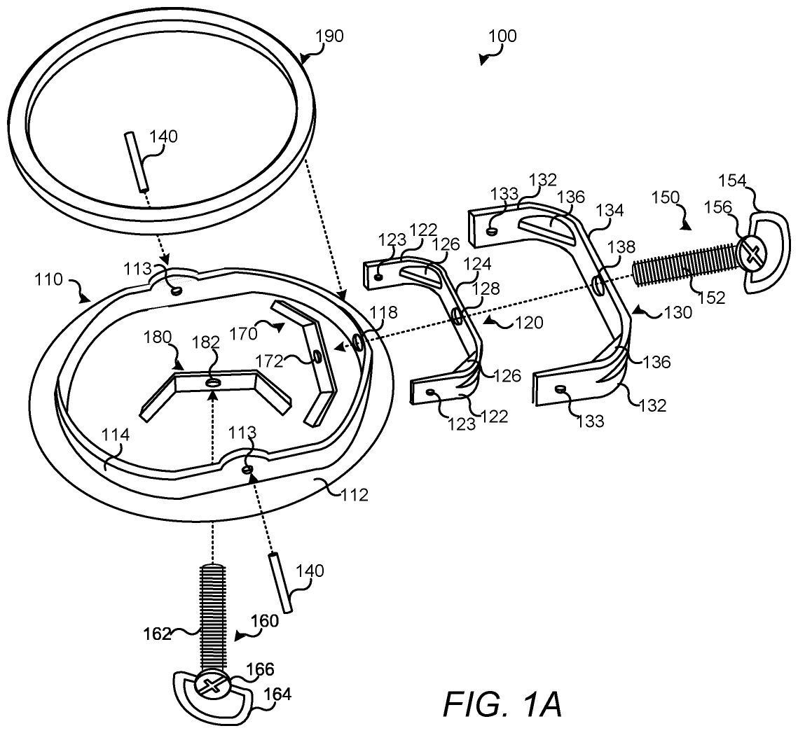

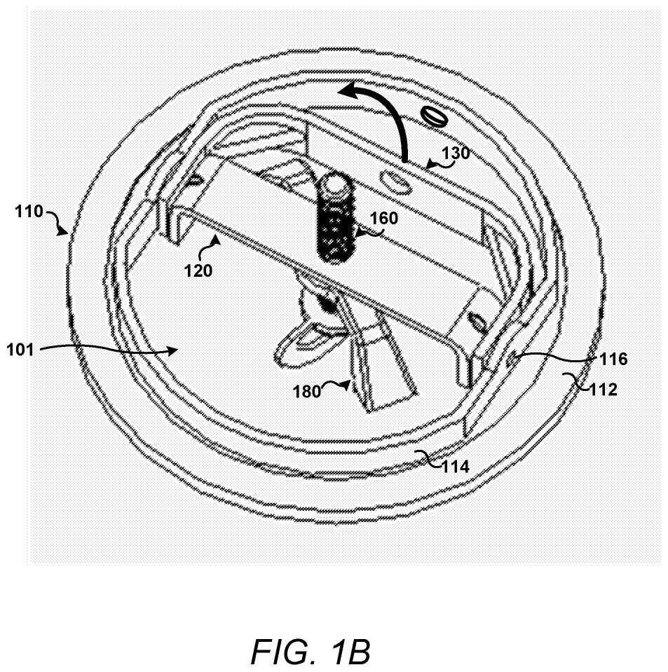

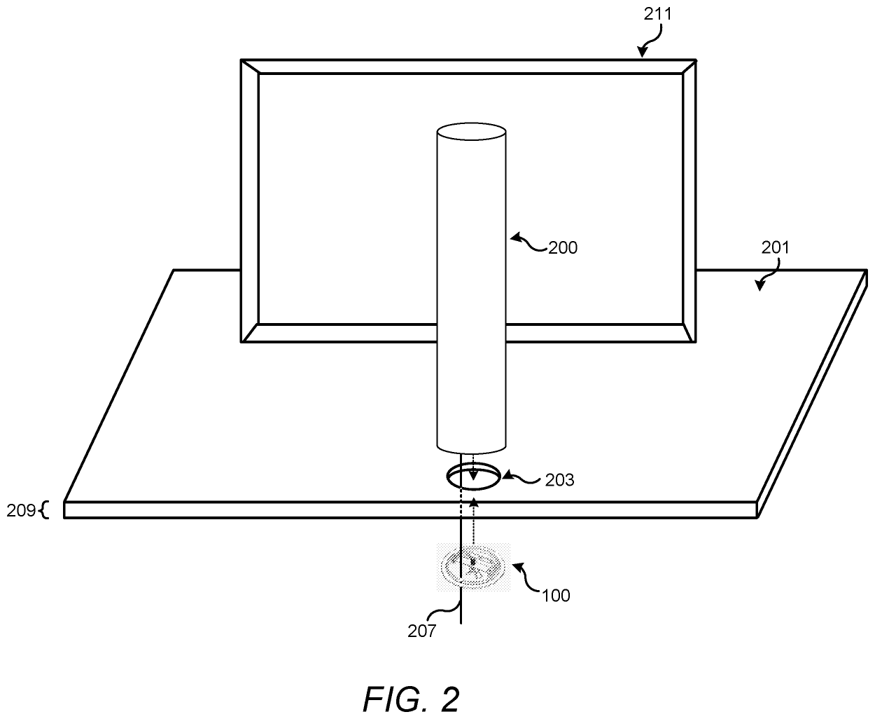

Reference will now be made to FIG. 1A, which shows an exploded, perspective view of an example apparatus 100 for securing a mount (such as a mount 200 illustrated in FIGS. 2-5D) to a substrate (such as substrate 201 illustrated in FIGS. 2-5D). As shown in FIG. 1A, the apparatus 100 may include a collar 110, a first bracket 120, a second bracket 130, a pair of pins 140, a bracket retaining screw 150, a mount retaining screw 160, a nut 170, a nut 180, a ring 190, and/or other components.

As will be described in more detail below, the collar 110 may be coupled to the first bracket 120 (which will also be referred to herein as the “small bracket 120” for illustrative convenience) and the second bracket 130 (which will also be referred to herein as the “large bracket 130” for illustrative convenience) through a pair of pins 140, although other coupling mechanisms may be used as well. In some examples, the small bracket 120 may be movably coupled to the collar 110 from a first (down) position to a second (upright) position. In some examples, the large bracket 130 may be movably coupled to the collar 110 from a first (down) position to a second (upright) position. In these examples, the bracket retaining screw 150 and the nut 170 may secure the small bracket 120 and/or the large bracket 130 to the collar 110 when the small bracket 120 and/or the large bracket 130 are in the first (down) position. Although two brackets 120 and 130 are shown, other numbers of brackets may be used and attached as described herein as well. Thus, the use of the terms “small bracket” and “large bracket” are used for illustrative clarity to show relative sizes of the brackets with respect to one another and not intended to limit the number of brackets that may be used.

The collar 110 may include a flange 112, a pair of pin retaining holes 113, a collar wall 114, a collar screw hole 118, and/or other features. The outer edge (such as diameter) of the flange 112 may be sized to be larger than the size of a substrate through hole through which the apparatus 100 is to retain a mount. As such, the flange 112 may prevent the apparatus 100 from being completely inserted into the substrate through hole. The collar wall 114 may include a wall abutting the flange 112. The collar wall 114 may be generally shaped and sized to fit within the substrate through hole. The collar wall 114 may include the pair of pin retaining holes 113. Each pin retaining hole 113 may be oriented on opposing portions of the collar wall 114. Furthermore, in some examples as shown, a pin retaining hole 113 may be included in a raised portion of the collar wall 114.

The small bracket 120 may include a pair of arms 122, a pair of pin retaining holes 123, a body 124, a pair of gussets 126, a first bracket screw hole 128, and/or other features. Each arm 122 of the pair of arms 122 may extend outwardly from the body 124 by a first distance. In some examples, the pair of arms 122 and the body 124 may be formed from a unitary structure by bending the unitary structure to form the arms 122 and the body 124. In other examples, the pair of arms 122 and the body 124 may be formed from individual materials that are fused together (such as by welding, chemically adhering, etc.). Whichever manner is used to transition each arm 122 to the body 124, in some examples, each arm 122 and body 124 transition may be structurally strengthened by a respective gusset 126.

In some examples, each arm 122 may be sized to extend the small bracket 120 up to or past the height of the collar wall 114 to account for a first thickness of the substrate when the apparatus 100 is to secure a mount to the substrate through the substrate through hole. In some examples, each arm 122 may be sized so that the small bracket 120, when in the upright position, contacts the mount. In other examples, each arm 122 may be sized so that the small bracket 120, when in the upright position, does not contact the mount but still provides stability for the mount retaining screw 160.

In some examples, the first bracket screw hole 128 may receive the mount retaining screw 160 when the small bracket 120 is in the upright position. In some examples, the first bracket screw hole 128 may itself be threaded on an inner surface to receive threads of the mount retaining screw 160. In other examples, the first bracket screw hole 128 may be unthreaded and manufactured to be larger than the mount retaining screw 160.

In some examples, the first bracket screw hole 128 may receive the bracket retaining screw 150 when the small bracket 120 is in the down position. In these examples, the bracket retaining screw 150 may be threaded or placed through the first bracket screw hole 128 and threaded or placed through the collar screw hole 118 to retain the small bracket 120 to the collar 110 when the small bracket 120 is in the down position. In some examples, the bracket retaining screw 150 may be further threaded through a nut screw hole 172 so that the nut 170 secures together the assembly of the bracket retaining screw 150, the small bracket 120, and the collar 110 when the small bracket 120 is in the down position. It should be noted that the small bracket 120 may be fixed in the upright position instead of being movable.

The large bracket 130 may be a larger version of the small bracket 120 and have similar features to the small bracket 120, except that the arms 132 of the body 134 may be larger to extend past the collar wall 114 (when the large bracket 130 is in the upright position) by a greater length than the small bracket 120 when the small bracket 120 is in the upright position.

For example, the large bracket 130 may include a pair of arms 132, a pair of pin retaining holes 133, a body 134, a pair of gussets 136, a second bracket screw hole 138, and/or other features. Each arm 132 of the pair of arms 132 may extend outwardly from the body 134 by a second distance. In some examples, the pair of arms 132 and the body 134 may be formed from a unitary structure by bending the arms 132. In other examples, the pair of arms 132 and the body 134 may be formed from individual materials that are fused together (such as by welding, chemically adhering, etc.). Whichever manner is used to transition each arm 132 to the body 134, in some examples, each arm 132 and body 134 transition may be structurally strengthened by a respective gusset 136.

In some examples, each arm 132 may be sized to extend the large bracket 130 past the height of the collar wall 114 to account for a second thickness of the substrate when the apparatus 100 is to secure a mount to the substrate through the substrate through hole. The second thickness may be greater than the first thickness. In some examples, each arm 132 may be sized so that the large bracket 130, when in the upright position, contacts the mount. In other examples, each arm 132 may be sized so that the large bracket 130, when in the upright position, does not contact the mount but still provides stability for the mount retaining screw 160. In some examples, each arm 132 may include a pair of pin retaining holes 133 that are to each receive a respective pin 140 to secure the large bracket 130 to an assembly of the collar 110, small bracket 120, and large bracket 130, as will be described below.

In some examples, the second bracket screw hole 138 may receive the mount retaining screw 160 when the large bracket 130 is in the upright position. In some examples, the second bracket screw hole 138 may itself be threaded on an inner surface to receive threads of the mount retaining screw 160. In other examples, the second bracket screw hole 138 may be unthreaded and manufactured to be larger than the mount retaining screw 160.

In some examples, the second bracket screw hole 138 may receive the bracket retaining screw 150 when the large bracket 130 is in the down position. In these examples, the bracket retaining screw 150 may be threaded or placed through the collar screw hole 118 and threaded or placed through the second bracket screw hole 138 to retain the large bracket 130 to the collar 110 when the large bracket 130 is in the down position. In some examples, the bracket retaining screw 150 may be further threaded through a nut screw hole 172 so that the nut 170 secures together the assembly of the bracket retaining screw 50, the second bracket 130, and the collar 110 when the large bracket 130 is in the down position.

In some examples, each pin 140 of the pair of pins 140 may respectively be inserted through the pin retaining holes 113, 123, and 133 to retain together an assembly of the collar 110, small bracket 120, and large bracket 130. In some examples, the pin retaining holes 113, 123, and 133 may be substantially the same size as one other and the pins 140 may be sized to permit movement of the small bracket 120 and/or the large bracket 130 around an axis (corresponding to the dashed arrows from an end of each pin) of the pin 140 while retaining the assembly through friction. Alternatively, or additionally, each pin 140 may include flanges (not shown) on each distal end that secures the pin 140 while permitting motion about the axis of the pin 140. Furthermore, each pin 140 may be threaded (and have a screw head) or unthreaded and each inner surface of the pin retaining holes 113, 123, and 133 may accordingly be threaded or unthreaded. It should also be noted that other securing features other than pins 140 may be used as well, such as rivets or other features that permit rotatable movement of the small bracket 120 and/or large bracket 130 about the collar 110 from a down to an upright position.

In some examples, the bracket retaining screw 150 may include a threaded shaft 152, a thumb screw portion 154, a head 156, and/or other features. The threaded shaft 152 may be threaded through the collar screw hole 118, the first bracket screw hole 128f, the second bracket screw hole 138, and/or the nut screw hole 172 so that the nut 170 may secures the small bracket 120 and/or the large bracket 130 to the collar 110 when the small bracket 120 and/or the large bracket 130 are in the down position. The thumb screw portion 154 may be shaped and sized to facilitate screwing the bracket retaining screw 150 by hand. The head 156 may include a portion for screwing the bracket retaining screw 150 by a tool.

In some examples, the mount retaining screw 160 may include a threaded shaft 162, a thumb screw portion 164, a head 166, and/or other features. The threaded shaft 162 may be threaded through the nut screw hole 182 so that the nut 180 may secure small bracket 120 and/or the large bracket 130 to the mount retaining screw 160 when the small bracket 120 and/or the large bracket 130 is in the upright position. In this configuration, the small bracket 120 and/or the large bracket 130 may provide strength and stability for the mount retaining screw 160 to engage the mount. The thumb screw portion 164 may be shaped and sized to facilitate screwing the mount retaining screw 160 by hand. The head 166 may include a portion for screwing the mount retaining screw 160 by a tool. In some examples, the first bracket screw hole 128 and the second bracket screw hole 138 may be substantially centered in their respective bodies 124 and 134. In this manner, the mount retaining screw 160 will be substantially centered within the substrate through hole when the apparatus 100 retains the mount through the substrate through hole. Such centered configuration may facilitate easy installation for an end user as well as strengthened retention of the mount as compared to a non-centered configuration.

In some examples, the ring 190 may be sized to be placed on the flange 112 and around the collar wall 114. When the apparatus 100 is to retain the mount, the ring 190 may be placed between the flange 112 and the surface of the substrate. The ring 190 may be manufactured from a material that is less abrasive or softer than materials used for the flange 112. For example, the ring 190 may be manufactured using foam, rubber, plastics, and the like. Thus, the ring 190 may facilitate use of the apparatus 100 with and preventing damage to fragile substrates such as glass or soft woods. Each of the components illustrated in FIG. 1A may be manufactured using various materials such as metals, plastics, and/or other materials suitable for retaining a mount against a surface as disclosed herein.

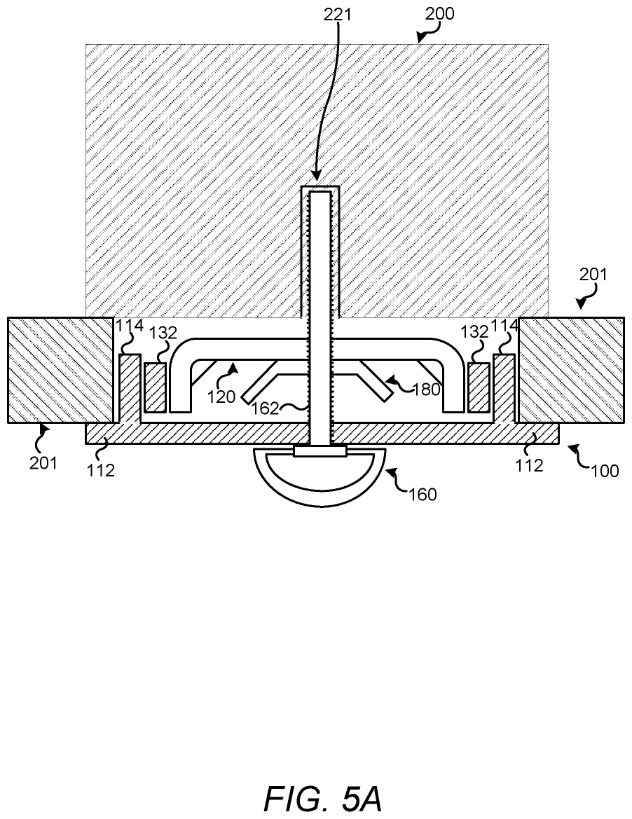

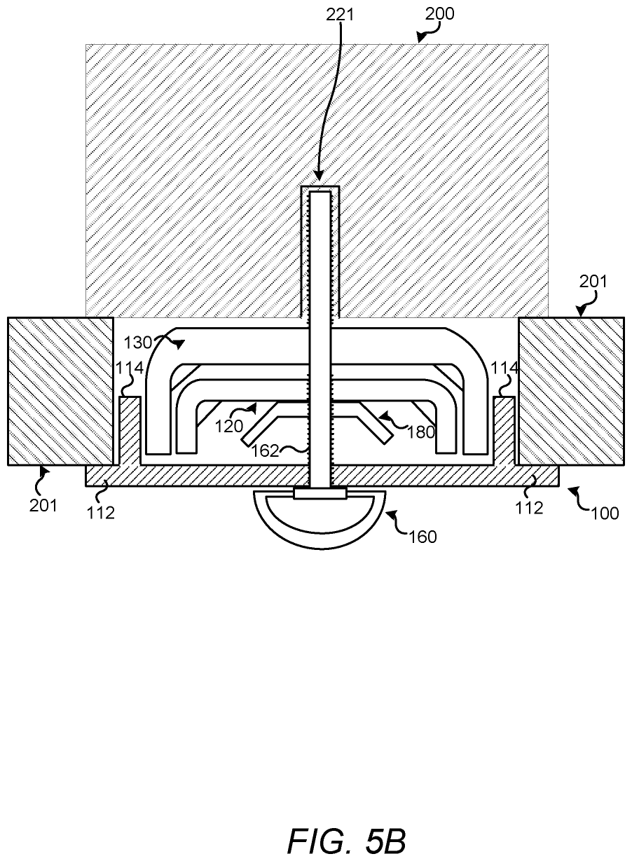

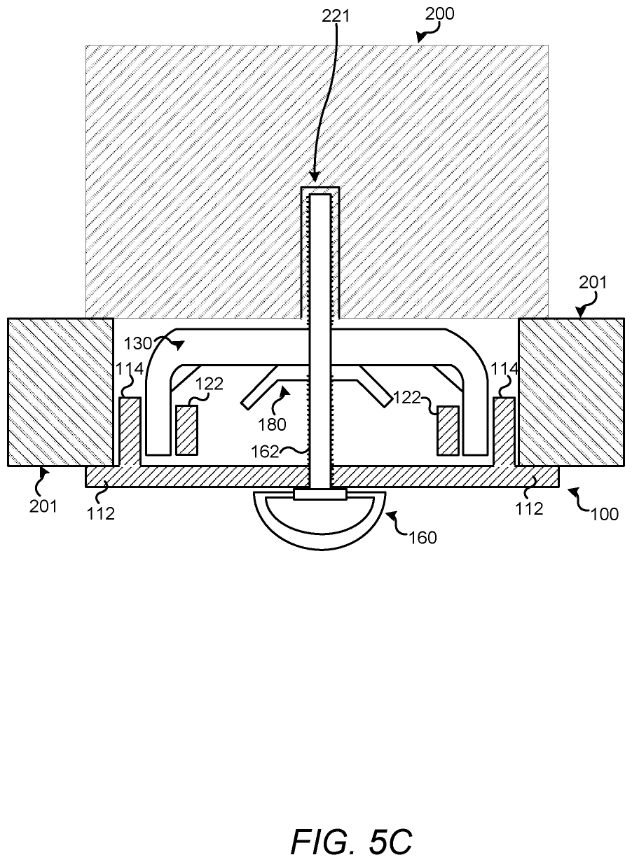

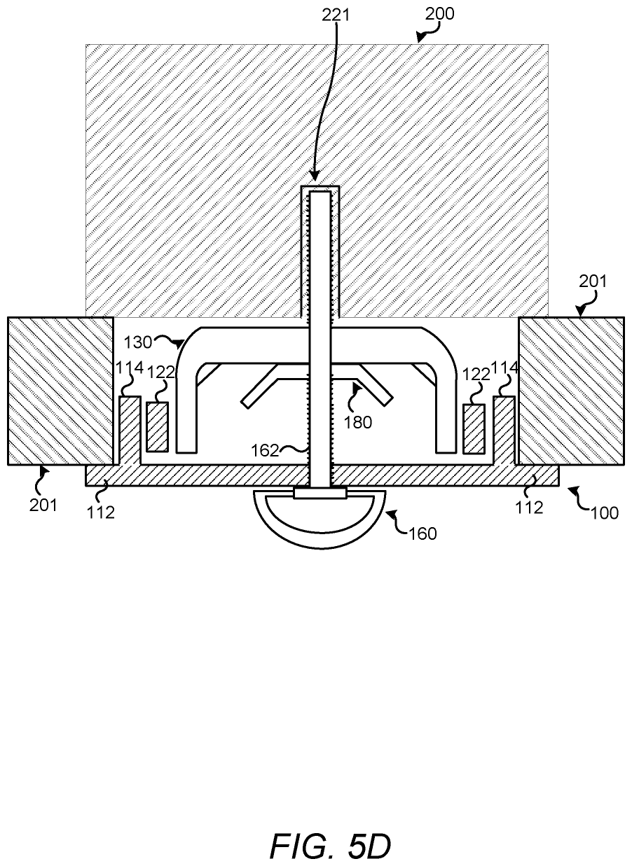

FIG. 1B shows a perspective view, in partial cross-section, of an assembled example of the apparatus 100 illustrated in FIG. 1A. Not all features of the apparatus 100 shown in FIG. 1A is depicted in FIG. 1B for illustrative clarity. As shown in FIG. 1B, the small bracket 120 is in the upright position and the large bracket 130 is in the down position. The curved arrow shows the direction in which the large bracket 130 may be moved from the down position to the upright position. In some examples, the collar 110, the small bracket 120, and the large bracket 130 may define a through-space 101 through which wires from the mount may be passed therethrough. Although FIG. 1B shows the large bracket 130 assembled in between the small bracket 120 and the collar 110, the position of the large bracket 130 and the small bracket 120 may be switched so that the large bracket 130 is assembled in between the small bracket 120 and the collar 110, as will be shown in FIG. 5D.

FIG. 2 shows an unassembled perspective view of an example device mounting system that includes the apparatus 100 depicted in FIGS. 1A and 1B. The system may include the apparatus 100, a mount 200 to be retained by the apparatus 100, a device 211 supported by the mount, a substrate 201 having a thickness 209, a substrate through hole 203, and wires 207. Different substrates 201 may have different thicknesses 209. The apparatus 100 may be adjusted as described herein to account for different thickness 209 of different substrates 201.

The device 211 may include an AIO device, although other types of devices may be supported by the mount 200. The mount 200 may attach to and support the device 211 to the substrate 201. The details of securing the mount 200 to the device 211 are omitted since they are not pertinent to the disclosure. Although the mount 200 is shown to have a cylindrical shape, other shapes may be used as well. Furthermore, although the substrate through hole 203 is shown to be generally circular, any shape of the substrate through hole 203 may be used.

In some examples, the mount 200 is to be placed on a first (top) surface of the substrate 201 at the substrate through hole 203. In some examples, the apparatus 100 is to be engaged with the substrate through hole 203 at a second (bottom) surface of the substrate 201. The apparatus 100 may retain the mount 200 via the mount retaining screw 160, which may be screwed (such as by hand or tool) to the mount 200 through the substrate through hole 203. In some examples, the wires 207 may be inserted through an internal passageway (not illustrated) of the mount 200 and through the substrate through hole 203.

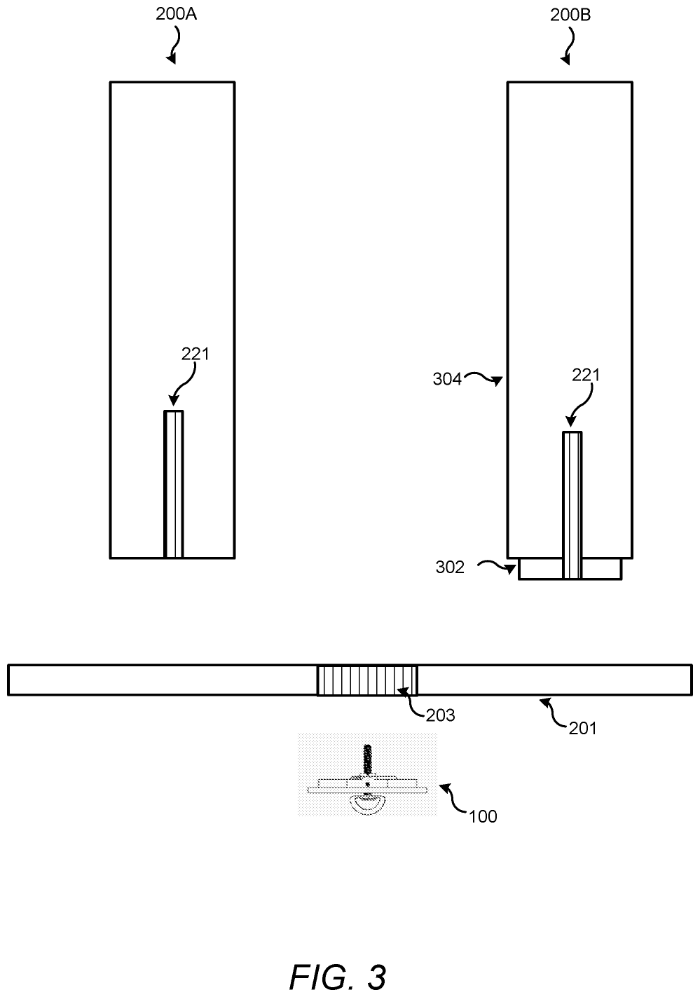

FIG. 3 shows examples of mounts 200A and 200B that may be secured to a surface by the apparatus depicted in FIGS. 1A and 1B. In one example, the mount 200A has a flat bottom surface that is to be flush with the surface of the substrate 201 and has a bottom area that is larger than the substrate through hole 203. In another example, the mount 200B has a substrate insertion portion 302 that is smaller than an area of the remaining portion (such as shaft) 304 of the mount 200B. The substrate insertion portion 302 may have a bottom area that is less than or equal to the substrate through hole 203 so that the substrate insertion portion 302 is to be inserted into the substrate through hole 203 while the remaining portion 304 is not inserted into the substrate through hole 203.

In each of mounts 200A or 200B, the mount may include a threaded screw hole 221 that is to receive the mount retaining screw 160 of the apparatus 100. In some examples, the threaded screw hole 221 may be centered at the area of the mount 200 that contacts the surface of the substrate 201. For the example mount 200B, the threaded screw hole 221 may be included in the substrate insertion portion 302 and (in some examples) may extend to the remaining portion 304 of the mount 200B.

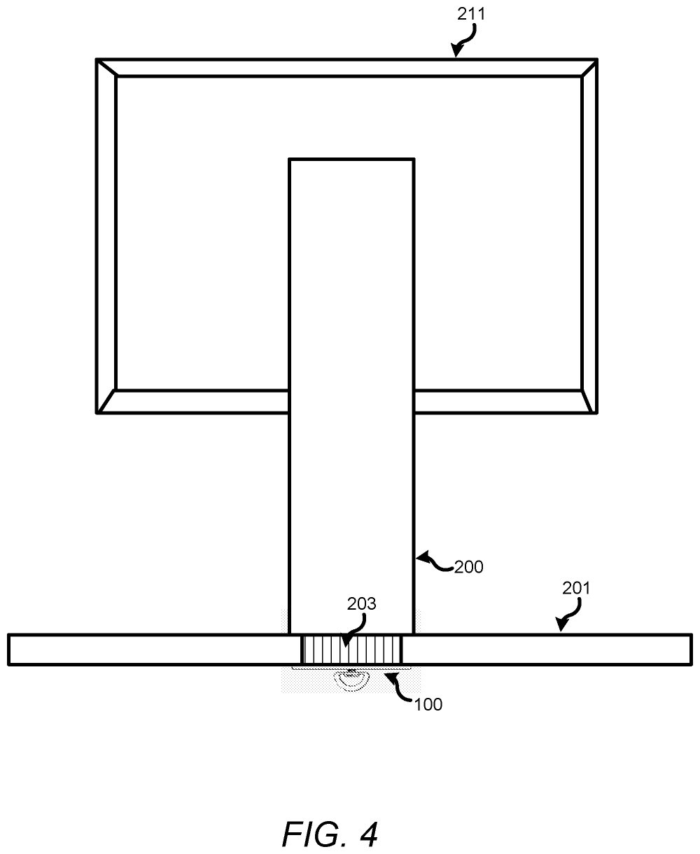

FIG. 4 shows an assembled view, in partial cross section, of an example system depicted in FIGS. 2 and 3. The apparatus 100 may be screwed or otherwise coupled to the mount 200 through the substrate through hole 203 (which is shown in cross-section) of the substrate 201. As such, the apparatus 100 may retain the mount 200 to the substrate 201. In various examples, the apparatus 100 may be considered an adjustable counter-mount since the apparatus 100 retains the mount 200 to the substrate 201.

FIG. 5A shows a side view in partial cross-section of an example assembly of an apparatus 100 securing the mount 200 to a surface of a substrate 201 in a configuration in which a first (small) bracket 120 is in an upright position and a second (large) bracket (shown by its arms 132) is in a down position to accommodate a first thickness of the substrate 201.

As shown in FIG. 5A, the mount retaining screw 160 may be secured to the small bracket 120 via the nut 180, and may retain the mount 200 to secure the mount to the substrate 201 via threaded screw hole 221. The large bracket (indicated by the arms 132 of the large bracket in cross section) is in the down position. Although the small bracket 120 is shown not touching the mount 200, this is for illustrative clarity, as the small bracket 120 may be sized to contact (or not contact) the mount 200 when the small bracket 120 is in the upright position.

FIG. 5B shows a side view side view in partial cross-section of an example assembly of an apparatus 100 securing a mount 200 to a surface of a substrate 201 in a configuration in which the first (small) and second (large) brackets 120 and 130 are in an upright position to accommodate a second thickness of the substrate 201.

As shown in FIG. 5B, the mount retaining screw 160 may be secured to the small bracket 120 via the nut 180, and may retain the mount 200 to secure the mount to the substrate 201. As shown in FIG. 5B, the large bracket 130 is also in the upright position. Although the large bracket 130 is shown not touching the mount 200, this is for illustrative clarity, as the large bracket 130 may be sized to contact (or not contact) the mount 200 when the large bracket 130 is in the upright position. In this example, the mount retaining screw 160 may be passed through both the small bracket 120 and the large bracket 130 to retain the mount 200 via threaded screw hole 221.

FIG. 5C shows a side view in partial cross-section of an example assembly of an apparatus 100 securing a mount 200 to a surface of a substrate 201 in a configuration in which the first (small) bracket (shown by its arms 122) is in a down position and the second (large) bracket 130 is in an upright position to accommodate the second thickness of the substrate 201.

As shown in FIG. 5C, the mount retaining screw 160 may be secured to the large bracket 130 via the nut 180, and may retain the mount 200 to secure the mount to the substrate 201 via threaded screw hole 221. The small bracket (indicated by the arms 122 of the small bracket in cross section) is in the down position. Although the large bracket 130 is shown not touching the mount 200, this is for illustrative clarity, as the large bracket 130 may be sized to contact (or not contact) the mount 200 when the large bracket 130 is in the upright position. In this example, the mount retaining screw 160 may be passed through the large bracket 130 to retain the mount 200 via the threaded screw hole 221 while the small bracket 120 is in the down position (as shown by the arms 122 in cross section).

FIG. 5D shows a side view in partial cross-section of an example assembly of an apparatus 100 securing a mount 200 to a surface of a substrate 201 in a configuration in which the first (small) bracket is in a down position and the second bracket is in an upright position to accommodate the second thickness of the substrate and the second bracket is in an inside configuration relative to the first bracket. In this example, the assembly is similar to the assembly illustrated in FIG. 5C, except that the large bracket 130 shown in FIG. 5D is placed between the small bracket and the collar walls 114 of the collar of the apparatus 100. In the example assembly shown in FIG. 5D, the small bracket (120—reference not shown in FIG. 5D) and the large bracket 130 are not both in the upright position simultaneously. Rather, one or the other may be in the upright position, but not both.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus, comprising:
a collar to be retained in a substrate through hole of a substrate;
a mount retaining screw to couple the apparatus to a mount and the substrate;
a first bracket coupled to the collar, the first bracket comprising a first bracket screw hole; and
a second bracket coupled to the collar, the second bracket comprising a second bracket screw hole, wherein the second bracket is adjustable from a first position to a second position;
wherein when the second bracket is in the first position, the mount retaining screw is to be received through the first bracket screw hole to retain the mount for a first thickness of the substrate, and
when the second bracket is in the second position, the mount retaining screw is to be received through the second bracket screw hole to retain the mount to adjust to a second thickness of the substrate.

2. The apparatus of claim 1, wherein the first bracket comprises a first body and a first pair of arms, each first arm of the first pair of arms extending from the first body by a first distance, the first body comprising the first bracket screw hole, wherein the second bracket comprises a second body and a second pair of arms, each second arm of the second pair of arms extending from the second body by a second distance, the second body comprising the second bracket screw hole, and
wherein the second distance is greater than the first distance so that the second bracket when in the second position extends past the first bracket to adjust to the second thickness of the substrate.

3. The apparatus of claim 2, wherein the second bracket is movably coupled to the collar via the second pair of arms, and the first bracket is coupled to the collar via the first pair of arms.

4. The apparatus of claim 3, wherein the second pair of arms is arranged between the first pair of arms and the collar so that when the second bracket is in the second position, the mount retaining screw is also to be inserted through the first bracket screw hole.

5. The apparatus of claim 1, wherein the collar comprises a collar screw hole, and wherein when the second bracket is in the first position, a second bracket retaining screw is to be inserted through the second bracket screw hole and the collar screw hole to secure the second bracket in the first position.

6. The apparatus of claim 5, further comprising a nut disposed between the mount retaining screw and the first bracket to secure the mount retaining screw to the first bracket.

7. The apparatus of claim 5, wherein the first bracket screw hole is substantially centered in the first bracket and the second bracket screw hole is substantially centered in the second bracket so that the mount retaining screw is substantially centered in the collar.

8. The apparatus of claim 1, wherein the collar comprises a flange having a diameter greater than a diameter of the substrate through hole that prevents the collar from being completely inserted into the substrate through hole.

9. The apparatus of claim 8, further comprising a ring coupled to the flange to protect a surface of the substrate.

10. A system comprising:
a mount; and
an apparatus to retain the mount to a substrate, the apparatus comprising:
a collar;
a first bracket coupled to the collar, the first bracket comprising a first bracket screw hole; and
a second bracket coupled to the collar, the second bracket comprising a second bracket screw hole, wherein the second bracket is adjustable from a first position to a second position;
wherein when the second bracket is in the first position, a mount retaining screw is to be received through the first bracket screw hole to retain the mount for a first thickness of the substrate, and
when the second bracket is in the second position, the mount retaining screw is to be received through the second bracket screw hole to retain the mount to adjust to a second thickness of the substrate.

11. The system of claim 10, wherein the collar is to be retained in a substrate through hole of the substrate, and wherein the mount comprises a shaft having a diameter greater than a diameter of the substrate through hole, the shaft comprising a substrate insertion portion having a threaded screw hole to receive the mount retaining screw, and wherein a diameter of the substrate insertion portion is less than the diameter of the substrate through hole so that the shaft is partially insertable into the substrate through hole via the substrate insertion portion.

12. The system of claim 11, wherein the shaft comprises an internal passageway to receive wires of a device supported by the mount so that the wires extend through the internal passageway and past the substrate insertion portion.

13. The system of claim 12, wherein the collar, the first bracket, and the second bracket define a through-space through which the wires are to be inserted to extend past the substrate.

14. An adjustable counter-mount, comprising:
a collar to be retained in a substrate through hole of a substrate;
a first bracket coupled to the collar, the first bracket comprising a first bracket screw hole; and
a second bracket coupled to the collar, the second bracket comprising a second bracket screw hole, wherein the second bracket is adjustable from a first position to a second position;
wherein when the second bracket is in the first position, a mount retaining screw is to be received through the first bracket screw hole to retain the mount for a first thickness of the substrate, and
wherein when the second bracket is in the second position, the mount retaining screw is to be received through the second bracket screw hole to retain the mount to adjust to a second thickness of the substrate.

15. The adjustable counter-mount of claim 14, wherein the adjustable counter-mount includes the mount retaining screw and wherein the mount retaining screw comprises a thumb screw portion to be tightened by hand.
